(19) United States
(12) Patent Application Publication
(10) Pub. No.: US 2025/0309312 A1
(43) Pub. Date: Oct. 2, 2025

(54) FUEL CELL STACK

(71) Applicant: Honda Motor Co., Ltd., Tokyo (JP)

(72) Inventors: Kazuyoshi Miyajima, Saitama (JP); Yosuke Konno, Saitama (JP)

(21) Appl. No.: 19/063,220

(22) Filed: Feb. 25, 2025

(30) Foreign Application Priority Data
Mar. 29, 2024 (JP) 2024-058109

(51) Int. Cl. H01M 8/2475; H01M 8/248

(52) U.S. Cl. CPC H01M 8/2475; H01M 8/248

(57) ABSTRACT

A fuel cell stack including a cell stacked body, a housing surrounding the cell stacked body, a restriction member including a first end surface contacting an outer side surface of the cell stacked body through an opening formed in a side wall of the housing to restrict a movement of the cell stacked body, a support member supporting a second end surface of the restriction member to cover the opening, and a pressing member pressing the support member toward a surface of the side wall. The housing includes an outer side wall extending parallel to the side wall at a predetermined distance from the surface of the side wall on an outside of the side wall, and the pressing member is interposed between the outer side wall and support member such that the restriction member applies a predetermined pressing force to the cell stacked body.

### CROSS-REFERENCE TO RELATED APPLICATION

This application is based upon and claims the benefit of priority from Japanese Patent Application No. 2024-058109 filed on Mar. 29, 2024, the content of which is incorporated herein by reference.

### BACKGROUND OF THE INVENTION

### Field of the Invention

This invention relates to a fuel cell stack.

### Description of the Related Art

In recent years, technological developments have been made on a fuel cell that contribute to energy efficiency in order to ensure access to energy that is affordable, reliable, sustainable and advanced by more people. As a conventional technology related to a fuel cell stack used in this type of fuel cell, there is a known technique in which an interlayer is disposed between a cell stacked body and a case. Such a technology is described, for example, in Japanese Examined Patent Publication No. 6512118 (JP 6512118 B). In the technology described in JP 6512118 B, the interlayer is pressed via a compression body by fastening the compression body to the case with a bolt.

However, in the configuration where the interlayer is pressed through the compression body by screwing the bolts as in the technology described in JP 6512118 B, it is difficult to manage the load during bolt screwing, making it difficult to press the interlayer evenly against the cell stacked body.

### SUMMARY OF THE INVENTION

An aspect of the present invention is a fuel cell stack including: a cell stacked body including a plurality of power generation cells stacked in a predetermined direction; a housing surrounding the cell stacked body; a restriction member including a first end surface and a second end surface on an opposite side of the first end surface, the first end surface being configured to contact an outer side surface of the cell stacked body through an opening formed in a side wall of the housing so as to restrict a movement of the cell stacked body in a direction orthogonal to the predetermined direction; a support member configured to support the second end surface of the restriction member so as to cover the opening; and a pressing member configured to press the support member toward a surface of the side wall. The housing includes an outer side wall extending substantially parallel to the side wall at a predetermined distance from the surface of the side wall on an outside of the side wall, and the pressing member is interposed between the outer side wall and support member such that the restriction member applies a predetermined pressing force to the cell stacked body.

### BRIEF DESCRIPTION OF THE DRAWINGS

The objects, features, and advantages of the present invention will become clearer from the following description of embodiments in relation to the attached drawings, in which:

FIG. 1 is a perspective view schematically showing an overall configuration of a fuel cell stack according to the embodiment of the present invention;

FIG. 2 is a cross-sectional view taken along line II-II of FIG. 1;

FIG. 3 is a cross-sectional view taken along line III-III of FIG. 1;

FIG. 4 is an enlarged view of a portion IV in FIG. 2;

FIG. 5A is a front view of a shim included in a support portion in FIG. 4;

FIG. 5B is a view illustrating a modification of FIG. 5A;

FIG. 6A is a diagram illustrating an installation process of a restriction member in FIG. 4;

FIG. 6B is a diagram illustrating an installation process of the restriction member following FIG. 6A;

FIG. 6C is a diagram illustrating an installation process of the restriction member following FIG. 6B;

FIG. 7 is a diagram illustrating a configuration of the support portion in a case where the shim in FIG. 5B is used;

FIG. 8 is a view illustrating a modification of FIG. 4;

FIG. 9A is a diagram illustrating an installation process of a restriction member in FIG. 8; and

FIG. 9B is a diagram illustrating an installation process of the restriction member following FIG. 9A.

### DETAILED DESCRIPTION OF THE INVENTION

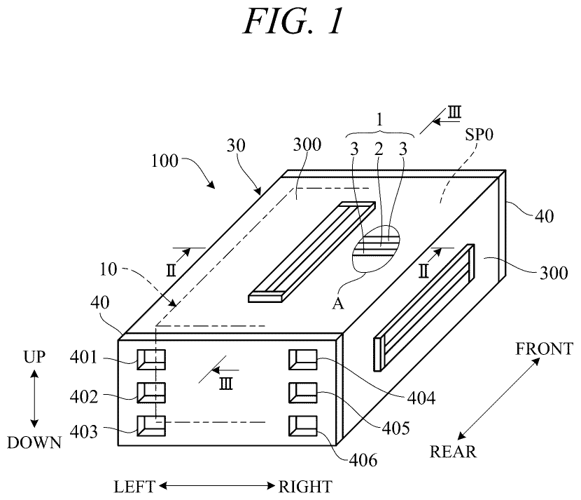

Hereinafter, an embodiment of the present invention will be described with reference to FIGS. 1 to 9B. A fuel cell stack according to an embodiment of the present invention is a main component of a fuel cell. The fuel cell is mounted on, for example, a vehicle and can generate electric power for driving the vehicle. The fuel cell can be mounted on various industrial machines in addition to a moving body other than a vehicle such as an aircraft or a boat, a robot, and the like.

FIG. 1 is a perspective view schematically showing an overall configuration of a fuel cell stack 100 according to the embodiment of the present invention. Hereinafter, for the sake of convenience, three-axis directions orthogonal to each other as illustrated in the drawing are defined as a front-rear direction, a left-right direction, and an up-down direction, and a configuration of each unit will be described according to such definitions. These directions may be different from a front-rear direction, a left-right direction, and an up-down direction of the vehicle. The front-rear direction in FIG. 1 is a stacking direction of the fuel cell stack 100, and when assembling the fuel cell stack 100, the stacking direction is aligned with the direction of gravity.

As illustrated in FIG. 1, the fuel cell stack 100 includes a cell stacked body 10, end units 40 disposed on both ends in the front-rear direction of the cell stacked body 10, and a case 30 surrounding the cell stacked body 10, and the whole of the fuel cell stack 100 has a substantially rectangular parallelepiped shape. The length of the fuel cell stack 100 in the left-right direction is longer than the length in the up-down direction.

The case 30 has four substantially rectangular side walls 300, each facing the top, right, bottom, and left surfaces of the cell stacked body 10. These four side walls 300 form a substantially box-shaped housing space SP0 with open the front and rear surfaces. The case 30 is composed of metals such as aluminum or iron. The end units 40 include terminal plates with conductivity, insulating plates with insulation disposed inside the end plates in the front-rear direction, and metal end plates disposed on both sides of the insulator in the front-rear direction.

In part “A” of FIG. 1, a portion of the side wall 300 of the case 30 is shown as broken. As illustrated in part “A” of FIG. 1, the cell stacked body 10 is a stacked body including a plurality of power generation cells 1 (for convenience, only a single cell 1 is illustrated) disposed in the housing space SP0. The power generation cell 1 has a unitized electrode assembly (hereinafter, referred to as a “UEA”) 2 including a membrane electrode assembly (hereinafter, referred to as a “MEA”) having an electrolyte membrane and an electrode, and separators 3 arranged on both front and rear sides of the UEA 2 to sandwich the UEA 2. The UEA 2 and the separator 3 are alternately arranged in the front-rear direction. The UEA 2 can also be referred to as a membrane electrode structure or a membrane electrode member.

The separator 3 has a pair of front and rear metal thin plates with a corrugated cross-section, which are integrally joined together by welding or the like at their outer peripheral edges. The separator 3 uses a conductive material with excellent corrosion resistance, such as stainless steel, titanium, or titanium alloy. The pair of thin plates (front plate and rear plate) are formed into an uneven shape by press molding or the like to form a gas flow path between the separator 3 and the UEA 2. More specifically, between the UEA 2 and the rear plate, an anode flow path through which fuel gas including hydrogen (anode gas) flows is formed. Between the UEA 2 and the front plate, a cathode flow path through which oxidant gas including oxygen (cathode gas) flows is formed. Between the pair of thin plates, a cooling flow path through which a cooling medium (for example, water) flows is formed.

The UEA 2 includes the MEA and a resin frame that supports a peripheral edge of the MEA. The MEA has an electrolyte membrane, an anode electrode provided on a front surface of the electrolyte membrane, and a cathode electrode provided on a rear surface of the electrolyte membrane. The electrolyte membrane is, for example, a solid polymer electrolyte membrane. The anode electrode has an electrode catalyst layer formed on the front surface of the electrolyte membrane and served as a reaction field for electrode reaction, and a gas diffusion layer formed on the front surface of the electrode catalyst layer to spread and supply the fuel gas. The cathode electrode has an electrode catalyst layer formed on the rear surface of the electrolyte membrane and served as a reaction field for electrode reaction, and a gas diffusion layer formed on the rear surface of the electrode catalyst layer to spread and supply the oxidant gas.

In the anode electrode, the fuel gas (hydrogen) supplied through the anode flow path and the gas diffusion layer is ionized by an action of a catalyst, passes through the electrolyte membrane, and moves to the cathode electrode side. Electrons generated at this time pass through an external circuit and are extracted as electric energy. In the cathode electrode, an oxidant gas (oxygen) supplied via the cathode flow path and the gas diffusion layer reacts with hydrogen ions guided from the anode electrode and electrons moved from the anode electrode to generate water. The generated water gives an appropriate humidity to the electrolyte membrane, and excess water is discharged to an outside of the UEA 2.

Through-holes 401 to 406 are opened in the rear end unit 40. Inside the cell stacked body 10, fuel gas is supplied through the through-hole 401, oxidant gas is supplied through the through-hole 404, and cooling medium is supplied through the through-hole 405. From the fuel cell stack 100, the fuel gas is discharged through the through-hole 406, the oxidant gas is discharged through the through-hole 403, and the cooling medium is discharged through the through-hole 402.

Although not shown, through-holes are opened in each UEA 2 and separators to communicate with the through-holes 401 to 406. Through the through-holes, the fuel gas is supplied to the anode flow path of each power generation cell 1, the oxidant gas is supplied to the cathode flow path, and the cooling medium is supplied to the cooling flow path. Also, through the through-holes, the fuel gas is discharged from the anode flow path, the oxidant gas is discharged from the cathode flow path, and the cooling medium is discharged from the cooling flow path.

The fuel cell stack 100 is assembled by, for example, the following procedure. First, one (for example, the rear side) end unit 40 is placed on a top surface of an assembly table. Next, the case 30 is placed on a top surface of the end unit 40, and the end unit 40 and one end portion (lower end portion) of the case 30 are fastened using bolts. Further, the plurality of power generation cells 1 are accommodated in the housing space SP0 in the case 30 through an opening in a top surface of the case 30, and a predetermined number of power generation cells 1 are stacked. At this time, the power generation cell 1 is stacked while being positioned with respect to the case 30 by a guide member (not illustrated) or the like provided on the inner wall surface of the case 30 and extending in the front-rear direction.

When a predetermined number of power generation cells 1 are stacked, the other (for example, the front side) end unit 40 is mounted, and a pressurizing force is applied to the entire stacked body from above using a pressurizer. When the upper end unit 40 is in contact with the other end portion (upper end portion) of the case 30 by the application of the pressurizing force, the end unit 40 and the other end portion of the case 30 are fastened to each other using bolts. This completes the assembly of the fuel cell stack 100. In a state in which the fuel cell stack 100 is assembled, the cell stacked body 10 is held in a state in which a predetermined compressive load is applied.

When such a fuel cell stack 100 is mounted on a vehicle, an inertial force corresponding to acceleration acting on the vehicle acts on the cell stacked body 10. For example, in a case where the stacking direction is the left-right direction of the vehicle, when acceleration in the front-rear direction acts on the vehicle during acceleration and deceleration of the vehicle, the inertial force acts on the cell stacked body 10 in a direction orthogonal to the stacking direction. In a case where the stacking direction is the front-rear direction of the vehicle, when lateral acceleration in the left-right direction acts on the vehicle when the vehicle turns, the inertial force acts on the cell stacked body 10 in a direction orthogonal to the stacking direction.

As described above, the inertial force acts on the cell stacked body 10 during normal driving of the vehicle. However, it is not only in that case, the inertial force also acts on the cell stacked body 10 when an impact force is applied to the vehicle from the outside. For example, in a case where the stacking direction is the left-right direction of the vehicle, when an impact is applied from the front side or the rear side by an object (for example, another vehicle) outside the vehicle, the inertial force acts on the cell stacked body 10 in a direction orthogonal to the stacking direction. In a case where the stacking direction is the front-rear direction of the vehicle, when an impact is applied from the right side or the left side by an object outside the vehicle (for example, another vehicle), the inertial force acts on the cell stacked body 10 in a direction orthogonal to the stacking direction.

When the inertial force acts on the cell stacked body 10 in a direction orthogonal to the stacking direction, a center portion of the cell stacked body 10 in the stacking direction is deformed in an arc shape. At this time, a shearing force acts on a stacking surface of the cell stacked body 10, and there is a possibility that positional displacement occurs on the stacking surface of the cell stacked body 10. In order to prevent such deformation and positional displacement of the cell stacked body 10 in the direction orthogonal to the stacking direction, a restriction member is provided in the fuel cell stack 100 according to the present embodiment.

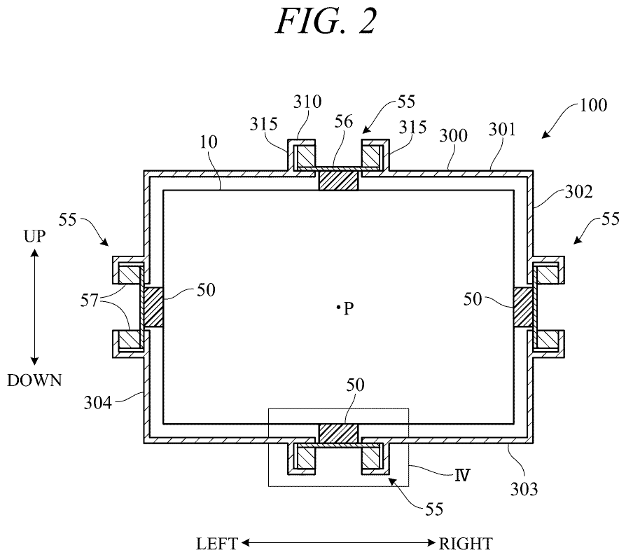

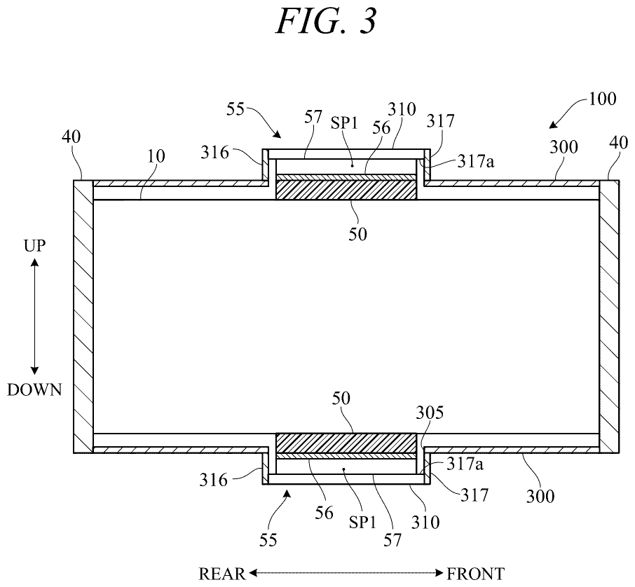

FIG. 2 is a cross-sectional view taken along the line II-II of FIG. 1, and FIG. 3 is a cross-sectional view taken along the line III-III of FIG. 1. In FIGS. 2 and 3, only the outer edge shape of the cell stacked body 10 is illustrated, and illustration of each power generation cell 1 (the UEA 2 and the separator 3) is omitted. A point P in FIG. 2 is an intermediate point in the left-right direction and an intermediate point in the up-down direction of the cell stacked body 10, and is referred to as a center point. Hereinafter, a side toward the center point P is referred to as an inner side, and a side away from the center point P is referred to as an outer side. As illustrated in FIG. 2, the restriction members 50 are provided at four locations around the cell stacked body 10.

More specifically, the restriction members 50 are provided to face a center portion in the left-right direction of the upper side wall 300 (upper wall 301), a center portion in the up-down direction of the right side wall 300 (right wall 302), a center portion in the left-right direction of the lower side wall 300 (lower wall 303), and a center portion in the up-down direction of the left side wall 300 (left wall 304). The restriction member 50 is an elastic body having an insulating property such as a resin material or a rubber material.

As illustrated in FIG. 3, the restriction member 50 has a substantially rectangular parallelepiped shape as a whole, and extends over a predetermined length in the front-rear direction at the center portion of each side wall 300 in the front-rear direction. The restriction members 50 may be provided near four corners of the cell stacked body 10. For example, a pair of restriction members 50 may be provided corresponding to each corner so as to sandwich the corner of the cell stacked body 10.

Each of the plurality of restriction members 50 is supported by the case 30, and has a function of preventing positional displacement due to the inertial force of the power generation cell 1, a function of receiving an external impact, and a function of absorbing the impact. The configurations of the plurality of restriction members 50 and the configurations of a plurality of support portions 55 that support the restriction members 50 from the case 30 are the same as each other.

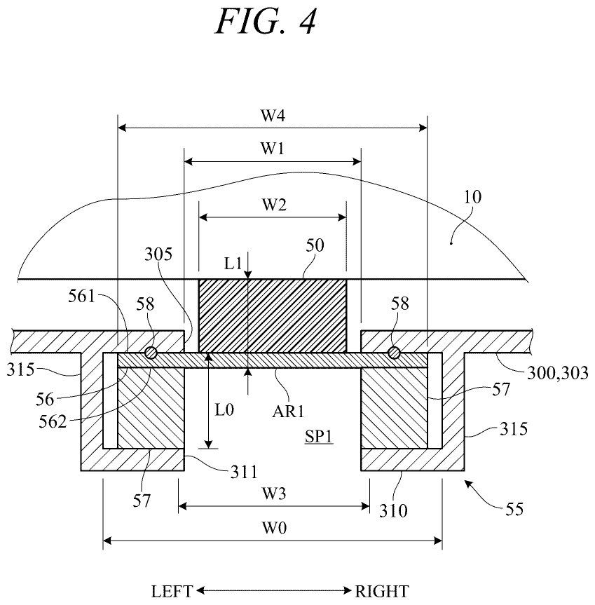

FIG. 4 is an enlarged view of a portion IV in FIG. 2. As illustrated in FIG. 4, on the outside of the side wall 300 (lower wall 303 in FIG. 4), an outer side wall 310 extends substantially parallel to the side wall 300. A pair of connecting portions 315 and 315 extends substantially perpendicularly to the outer side wall 310 from both end portions of the outer side wall 310 in the width direction (left-right direction in FIG. 4). The distal end portions of the pair of connecting portions 315 and 315 are connected to the outer surface of the side wall 300. For example, the connecting portion 315 and the side wall 300 are joined by welding. As a result, a substantially box-shaped outer space SP1 having a predetermined width WO and a predetermined height L0 and being elongated in the front-rear direction is formed between the side wall 300, the outer side wall 310, and the pair of connecting portions 315 and 315.

As illustrated in FIG. 3, a rear end wall 316 is provided on the rear end surface of the outer side wall 310 so as to cover the rear end portion of the outer space SP1. The end portion of the rear end wall 316 is connected to the surface of the side wall 300, for example, by welding, whereby a rear end opening of the outer space SP1 is closed. A front end wall 317 as a cover member is detachably attached to the front end surface of the outer side wall 310 by, for example, a bolt, whereby a front end opening 317a of the outer space SP1 is closed.

As illustrated in FIG. 4, the side wall 300 is provided with a substantially rectangular opening 305 that is elongated in the front-rear direction at the center portion in the left-right direction of the outer space SP1. The width W1 of the opening 305 is smaller than the width W0 of the outer space SP1 and larger than the width W2 of the restriction member 50. The outer side wall 310 is provided with a substantially rectangular outer opening 311 that is elongated in the front-rear direction at the center portion in the left-right direction. The width W3 of the outer opening 311 is smaller than the width W0 of the outer space SP1 and is equal to the width W1 of the opening 305. The width W3 of the outer opening 311 may be larger than the width W1 of the opening 305, or may be smaller than the width W1 of the opening 305.

In the outer space SP1, a flat plate-shaped support plate 56 having a predetermined thickness is accommodated through the front end opening 317a (FIG. 3). The width W4 of the support plate 56 is smaller than the width W0 of the outer space SP1 and larger than the widths W1 and W3 of the openings 305 and 311. The support plate 56 has an inner surface 561 facing the opening 305 and an outer surface 562 facing the outer opening 311.

The restriction member 50 is attached to a center portion of the inner surface 561 in the left-right direction via, for example, an adhesive. A substantially rectangular frame-shaped sealing member 58 (for example, O-ring) is attached to the inner surface 561 so as to surround the restriction member 50. The height L1 from the outer surface 562 of the support plate 56 to the inner end surface of the restriction member 50 is shorter than the height L0 of the outer space SP1.

A shim 57 having a predetermined thickness is inserted between the outer surface 562 of the support plate 56 and the outer side wall 310 through the front end opening 317a of the outer side wall 310. The thickness of the shim 57 is equal to or approximately equal to a value obtained by subtracting the thickness of the support plate 56 from the height L0 of the outer space SP1.

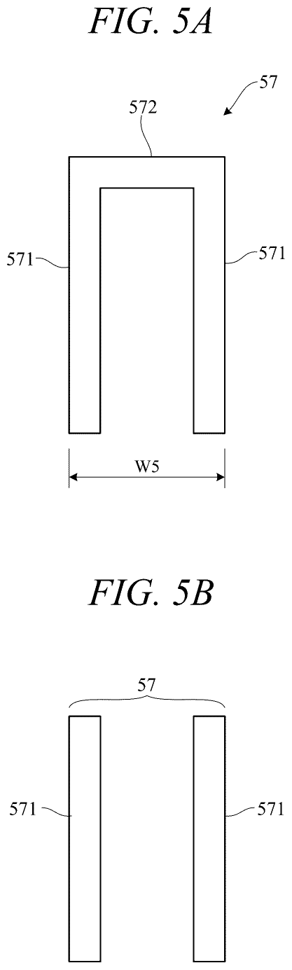

FIG. 5A is a front view of the shim 57. As illustrated in FIG. 5A, the shim 57 includes a pair of vertical plate portions 571 (pressing portions) extending substantially parallel to each other and a horizontal plate portion 572 (connecting portion) connecting end portions of the vertical plate portions 571, and has a substantially U shape as a whole. The width W5 of the shim 57 is the same as the width W4 (FIG. 4) of the support plate 56.

FIG. 4 illustrates a state in which the restriction member 50 is supported by the support portion 55. When the shim 57 is inserted between the support plate 56 and the outer side wall 310, the support plate 56 is held in the outer space SP1 in a state of being in contact with the outer surface of the side wall 300. The shim 57 has the pair of vertical plate portions 571 and 571. For this reason, when the shim 57 is inserted, a region AR1 at the center of the outer surface 562 of the support plate 56 in the left-right direction, that is, a region AR1 between the pair of vertical plate portions 571 and 571 is exposed to the outside.

When the shim 57 is inserted between the support plate 56 and the outer side wall 310, the sealing member 58 is crushed and the gap between the outer surface of the side wall 300 and the support plate 56 is sealed. At this time, the inner end surface of the restriction member 50 is in contact with the outer surface of the cell stacked body 10, whereby the movement of the cell stacked body 10 can be restricted.

The restriction member 50 is attached from the outside of the fuel cell stack 100 after the fuel cell stack 100 is assembled in a state where the fuel cell stack 100 stands with the front-rear direction (for example, the rear side) in FIG. 1 coinciding with the gravity direction. The restriction member 50 is attached as follows, for example.

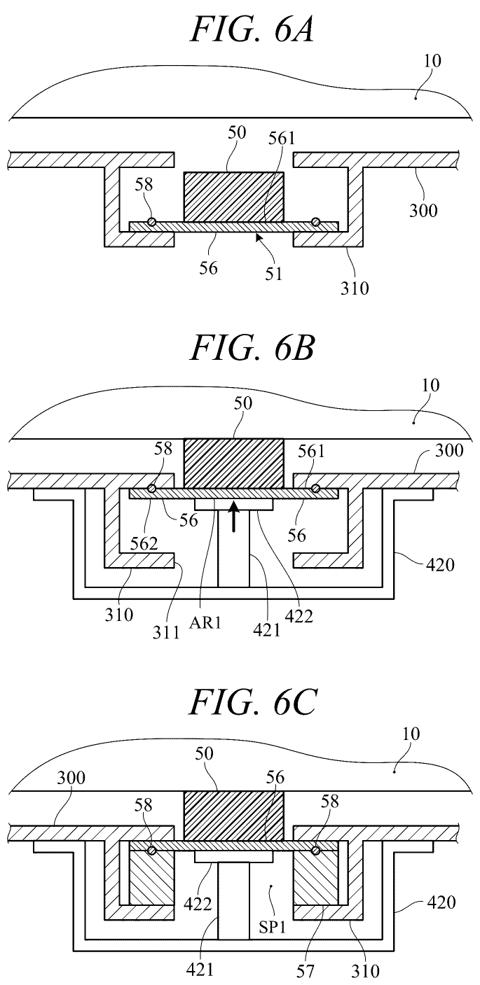

First, as illustrated in FIG. 6A, the restriction member 50 and the sealing member 58 are bonded to the inner surface 561 of the support plate 56 to form a restriction unit 51. Next, the restriction unit 51 is inserted into the outer space SP1 from above through the front end opening 317a (FIG. 3) on the outer side wall 310. At this time, the lower end portion of the restriction unit 51 is in contact with the rear end wall 316 (FIG. 3), and the downward movement of the restriction unit 51 is restricted.

Next, the restriction unit 51 is pushed toward the cell stacked body 10 using a cylinder. More specifically, as illustrated in FIG. 6B, a frame 420 is attached to the side wall 300 so as to cover the outside of the outer side wall 310. A telescopic cylinder 421 (for example, a pneumatic cylinder) is fixed to the frame 420 in advance, and a plate 422 elongated in the vertical direction is fixed to a distal end portion of the cylinder 421.

The plate 422 is in contact with the region AR1 of the outer surface 562 of the support plate 56 through the outer opening 311 of the outer side wall 310. In this state, the support plate 56 is pushed inward as indicated by an arrow in FIG. 6B while the sealing member 58 is crushed until the inner surface 561 of the support plate 56 is in contact with the outer surface of the side wall 300. By using the cylinder 421, a pushing force can be uniformly applied to the elongated support plate 56.

When the support plate 56 is in contact with the side wall 300, as illustrated in FIG. 6C, the shim 57 is inserted between the support plate 56 and the outer side wall 310 through the front end opening 317a on the outer side wall 310. More specifically, the shim 57 is inserted in a posture in which the horizontal plate portion 572 (FIG. 5A) is directed upward. The lower end portion of the shim 57 is in contact with the rear end wall 316 of the outer side wall 310. As a result, the restriction member 50 is held in a state of being pressed toward the cell stacked body 10 via the shim 57 and the support plate 56.

Next, the frame 420 integrated with the cylinder 421 is removed from the side wall 300. Further, the front end wall 317 is fastened to the front end surface of the outer side wall 310 with a bolt. As a result, the support plate 56 and the shim 57 are confined in the outer space SP1. Thus, the attachment of the restriction member 50 to the support portion 55 is completed.

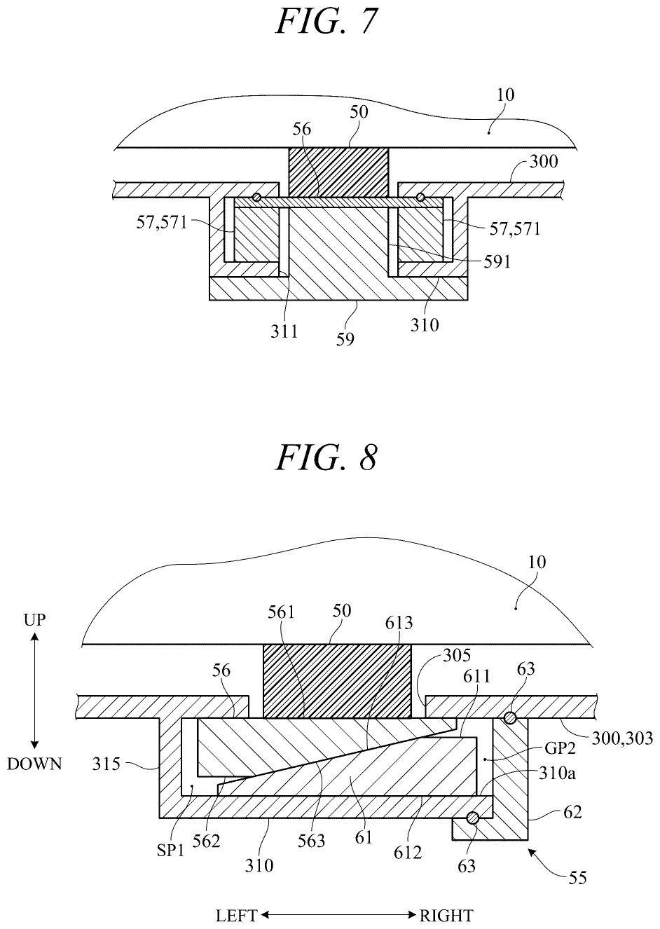

In FIG. 5A, the shim 57 is formed in a substantially U shape, but the shape of the shim 57 is not limited thereto. For example, as illustrated in FIG. 5B, the shim 57 may be configured by a pair of vertical plate portions 571. In this case, for example, as illustrated in FIG. 7, a cover 59 is attached to the outer side wall 310 via a bolt (not illustrated). The cover 59 has a protruding portion 591 protruding inward, and the protruding portion 591 is inserted between the pair of vertical plate portions 571 through the outer opening 311 of the outer side wall 310. As a result, the positions of the pair of vertical plate portions 571 can be regulated.

FIG. 8 is a diagram illustrating another example (modification of FIG. 4) of the support portion 55. In FIG. 8, unlike FIG. 4, the restriction member 50 is pushed toward the cell stacked body 10 using a wedge member 61 without using the cylinder 421. Hereinafter, the configuration of FIG. 8 will be described.

As illustrated in FIG. 8, the connecting portion 315 connecting the side wall 300 and the outer side wall 310 of the case 30 is provided so as to surround three sides of the outer side wall 310. Therefore, the outer space SP1 between the side wall 300 and the outer side wall 310 is opened only in one (the right side in FIG. 8) of the outer side walls 310. A cover 62 having a substantially L-shaped cross section as a cover member is attached to an end portion of the outer side wall 310 so as to close the opening 310a. The cover 62 is attached to the side wall 300 and the outer side wall 310 via the sealing member 63, and the entire circumference of the opening 310a is sealed by the sealing member 63.

Similarly to FIG. 4, the restriction member 50 is bonded to the inner surface 561 of the support plate 56 in advance. The plate thickness of the support plate 56 is larger than that in FIG. 4, and a tapered surface 563 is formed on the outer surface 562 of the support plate 56 such that the plate thickness gradually increases from the opening 310a toward the back side of the outer space SP1. The wedge member 61 has an inner surface 611 that is in contact with the support plate 56 and an outer surface 612 that is in contact with the outer side wall 310. The inner surface 611 is provided with a tapered surface 613 having an inclination angle corresponding to the tapered surface 563, and the tapered surfaces 563 and 613 are in contact with each other.

The restriction member 50 in FIG. 8 is temporarily fixed to the side wall 300 before the plurality of power generation cells 1 are stacked in the case 30 after the case 30 is fastened to one (for example, the rear side) end unit 40. Specifically, first, the support plate 56 is inserted into the outer space SP1 from the side (the right side in FIG. 8) through the opening 310a. Next, from the inside of the side wall 300, the restriction member 50 is adhered to the inner surface 561 of the support plate 56 via the opening 305. As a result, the restriction unit 51 in which the restriction member 50 and the support plate 56 are integrated, is formed.

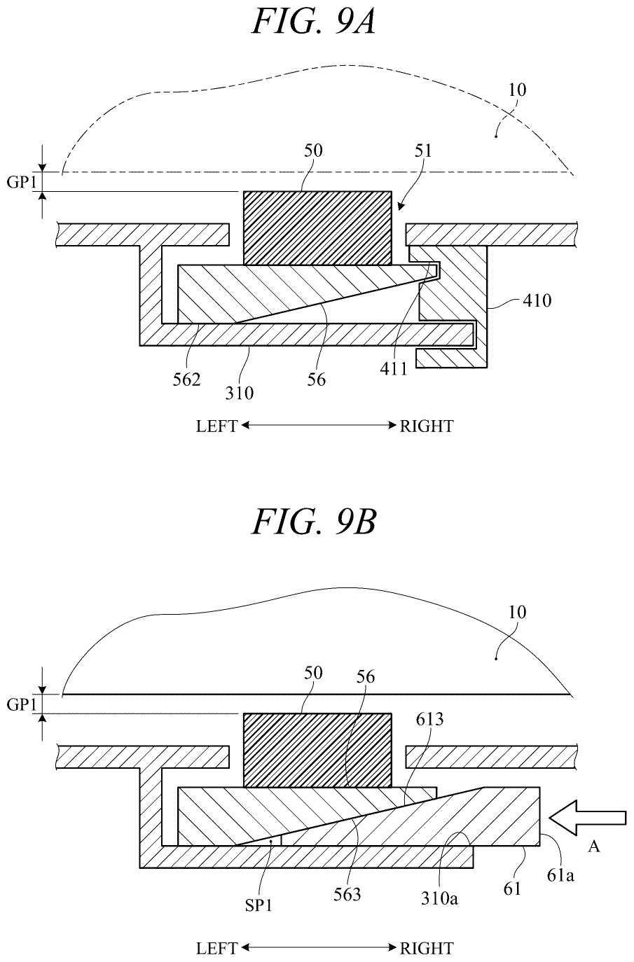

Next, as illustrated in FIG. 9A, a jig 410 is attached to the end portion of the outer side wall 310. The jig 410 is provided with a concave portion 411 into which the end portion of the support plate 56 is fitted. As a result, the restriction unit 51 is held in a state where the outer surface 562 of the support plate 56 is in contact with the outer side wall 310, and the restriction member 50 is retracted outward. In this state, the power generation cells 1 are stacked, and a pressurizing force is further applied from above via the end unit 40. By retracting the restriction member 50 outward, a gap GP1 of a predetermined distance is provided between the restriction member 50 and the cell stacked body 10. Therefore, the plurality of power generation cells 1 can be easily stacked in the case 30 without interfering with restriction member 50.

Next, as illustrated in FIG. 9B, the jig 410 is removed, and the wedge member 61 is inserted into the outer space SP1 through the opening 310a. Then, the tapered surface 563 of the support plate 56 and the tapered surface 613 of the wedge member 61 are caused to be in contact with each other. Thereafter, the end surface 61a of the wedge member 61 is hit with a hammer or the like, and the wedge member 61 is pushed in a direction of an arrow A. As a result, the restriction member 50 moves inward via the support plate 56. By using the wedge member 61, a pushing force can be uniformly applied to the support plate 56 having an elongated shape in the front-rear direction.

The wedge member 61 is pushed until the inner surface 561 of the support plate 56 is in contact with the outer surface of the side wall 300, as illustrated in FIG. 8. In a state where the support plate 56 is in contact with the side wall 300, the restriction member 50 is in contact with the cell stacked body 10. Next, the cover 62 is attached to the side wall 300 and the outer side wall 310 via the sealing member 63. At this time, although not illustrated, a spacer is interposed in a gap GP2 in the left-right direction between the wedge member 61 and the cover 62. As a result, the wedge member 61 can be fixed in the outer space SP1.

According to the present embodiment, the following functions and effects can be achieved.
(1) The fuel cell stack 100 includes: the cell stacked body 10 formed by stacking the plurality of power generation cells 1 in a predetermined stacking direction (front-rear direction); the case 30 surrounding the cell stacked body 10; the restriction member 50 whose inner end surface is in contact with the outer surface of the cell stacked body 10 through the opening 305 provided in the side wall 300 of the case 30 to restrict movement of the cell stacked body 10 in a direction orthogonal to the stacking direction; the support plate 56 that supports an outer end surface of the restriction member 50 and is provided to cover the opening 305; and the shim 57 or the wedge member 61 that presses the support plate 56 toward the surface of the side wall 300 (FIGS. 1, 4, and 8). The case 30 has the outer side wall 310 extending substantially parallel to the side wall 300 at a predetermined distance (predetermined height L0) from the surface of the side wall 300 at the outer side of the side wall 300 (FIG. 4). The shim 57 or the wedge member 61 is interposed between the outer side wall 310 and the support plate 56 such that the restriction member 50 applies a predetermined pressing force to the cell stacked body 10 (FIGS. 4 and 8).

In this manner, since the restriction member 50 is pressed toward the cell stacked body 10 via the support plate 56 by the shim 57 or the wedge member 61, the restriction member 50 elongated in the front-rear direction can be uniformly pressed. Therefore, the restriction member 50 is uniformly brought into close contact with the cell stacked body 10, and the restriction member 50 can be caused to function well as a positioning member, a load receiving member, and the like of the cell stacked body 10.
(2) The outer side wall 310 is provided with the outer opening 311 positioned opposite to the opening 305 (FIG. 4). The shim 57 has the pair of vertical plate portions 571 and 571 arranged on both sides of the space facing the region AR1 such that the region (predetermined region) AR1 of the support plate 56 facing the outer opening 311 is exposed (FIGS. 5A and 5B). As a result, the support plate 56 can be pressed by the cylinder 421 from the outside via the region AR1, and the shim 57 can be easily inserted into the gap generated by the pressing of the cylinder 421 from the outside.
(3) The support plate 56 has the inner surface 561 that is in contact with the surface of the side wall 300 and the outer surface 562 opposite the inner surface 561 (FIG. 8). The outer surface 562 includes the tapered surface 563 that is inclined with respect to the surface of the side wall 300 (FIG. 8). The wedge member 61 is configured in a wedge shape to be inserted between the outer surface 562 (tapered surface 563) and the outer side wall 310 of the support plate 56 (FIG. 8). As a result, the restriction member 50 can be uniformly pressed against the cell stacked body 10 with a simple configuration in which the wedge member 61 is simply inserted from the outside without using the cylinder 421.
(4) The fuel cell stack 100 further includes the sealing members 58 and 63 that prevent gas leakage from the opening 305 (FIGS. 4 and 8). As a result, it is possible to adopt a configuration in which the restriction member 50 is pressed from the outside through the opening 305 without causing gas leakage.

The above embodiment can be modified in various forms. Below, some modified examples are described. In the above embodiment, a substantially rectangular parallelepiped-shaped restriction member 50 is provided. However, as long as one end surface (a first end surface) contacts the outer surface of the cell stacked body through an opening formed in the side wall of the case 30 as a housing, and movement in a direction orthogonal to the predetermined stacking direction (a predetermined direction) of the cell stack is restricted, the configuration of a restriction member may be any configuration. For example, the restriction member may be formed in a substantially L-shape corresponding to the corner of the cell stacked body. In the above embodiment, the restriction member 50 is supported by the support plate 56. However, as long as the other end surface (a second end surface) of the restriction member is supported and provided to cover the opening of the side wall, the configuration of a support member is not limited to the above configuration.

In the above embodiment, the restriction member 50 is pressed toward the cell stacked body 10 by the shim 57 inserted between the support plate 56 and the outer side wall 310, or by the wedge member 61 inserted between the support plate 56 and the outer side wall 310. However, the configuration of a pressing member is not limited to the above configuration. That is, as long as the pressing member is interposed between the outer side wall and the support member such that the restriction member applies a predetermined pressing force to the cell stacked body, the configuration of a pressing member may be any configuration.

In the above embodiment (FIG. 4), the shim 57 having the pair of vertical plate portions 571 is configured to sandwich the space between the outer opening 311 and the central region AR1 of the support plate 56. However, as long as a pair of pressing portions are arranged on both sides of the space facing the predetermined region such that the predetermined region of the support member is exposed, the configuration of a pair of pressing portions is not limited to the above configuration. In the above embodiment (FIG. 8), the tapered surface 563 (an inclined surface) is formed on the outer surface 562 of the support plate 56 having the inner surface 561 (a first surface) and the outer surface 562 (a second surface), and the wedge member 61 is inserted between the outer surface 562 and the outer side wall 310. However, the configuration of a pressing member configured as a wedge shape is not limited to the above configuration. In the above embodiment, the sealing members 58 and 63 are provided around the opening 305 or outside the opening 305 to prevent gas leakage from the opening 305 of the side wall 300. However, the configuration of a sealing member is not limited to the above configuration.

The above embodiment can be combined as desired with one or more of the above modifications. The modifications can also be combined with one another.

According to the present invention, a restriction member can be easily and uniformly pressed against a cell stacked body.

Above, while the present invention has been described with reference to the preferred embodiments thereof, it will be understood, by those skilled in the art, that various changes and modifications may be made thereto without departing from the scope of the appended claims.

What is claimed is:

1. A fuel cell stack comprising:
a cell stacked body including a plurality of power generation cells stacked in a predetermined direction;
a housing surrounding the cell stacked body;
a restriction member including a first end surface and a second end surface on an opposite side of the first end surface, the first end surface being configured to contact an outer side surface of the cell stacked body through an opening formed in a side wall of the housing so as to restrict a movement of the cell stacked body in a direction orthogonal to the predetermined direction;
a support member configured to support the second end surface of the restriction member so as to cover the opening; and
a pressing member configured to press the support member toward a surface of the side wall, wherein
the housing includes an outer side wall extending substantially parallel to the side wall at a predetermined distance from the surface of the side wall on an outside of the side wall, and
the pressing member is interposed between the outer side wall and the support member such that the restriction member applies a predetermined pressing force to the cell stacked body.

2. The fuel cell stack according to claim 1, wherein
the outer side wall is provided with an outer opening facing the opening,
the pressing member includes a pair of pressing portions arranged on both sides of a space facing a predetermined region of the support member, such that the predetermined region is exposed through the outer opening.

3. The fuel cell stack according to claim 2, wherein
the housing further includes a connecting wall connecting the side wall and the outer side wall except for a predetermined opening region so as to enclose a space between the side wall and the outer side wall, and a cover member closing the predetermined opening region.

4. The fuel cell stack according to claim 2, wherein
the pressing member includes the pair of pressing portions, and a connecting portion connecting the pair of pressing portions.

5. The fuel cell stack according to claim 1, wherein
the support member includes a first surface contacting the surface of the side wall and a second surface on an opposite side of the first surface,
the second surface includes an inclined surface inclined with respect to the surface of the side wall, and
the pressing member is configured as a wedge shape so as to be inserted between the inclined surface and the outer side wall.

6. The fuel cell stack according to claim 5, wherein
the housing further includes a connecting wall connecting the side wall and the outer side wall except for a predetermined opening region so as to enclose a space between the side wall and the outer side wall, and a cover member closing the predetermined opening region.

7. The fuel cell stack according to claim 1, further comprising
a sealing member configured to prevent gas leakage from the opening.
